(19) United States
(12) Patent Application Publication
(10) Pub. No.: US 2026/0195873 A1
(43) Pub. Date: Jul. 9, 2026

(54) OPTIMIZED BOUNDING BOX ENGINE

(71) Applicant: QUALCOMM Incorporated, San Diego, CA (US)

(72) Inventors: Ganghee LEE, San Diego, CA (US); Vinay MELKOTE KRISHNAPRASAD, Bangalore (IN); Jerin GEO JAMES, Changanacherry (IN); Bhupinder Singh PARHAR, Escondido, CA (US); Eric LUTZ, San Diego, CA (US); Anil Kumar GOKAVARAPU, San Diego, CA (US)

(21) Appl. No.: 19/015,529

(22) Filed: Jan. 9, 2025

(51) Int. Cl. G06T 5/80; G06T 11/20

(52) U.S. Cl. CPC G06T 5/80; G06T 11/23; G06T 2210/12

(57) ABSTRACT

This disclosure provides systems, devices, apparatus, and methods, including computer programs encoded on storage media, for determining a bounding box for geometric correction. A bounding box engine may obtain an indication of a set of reprojection distortions. The bounding box engine may obtain an indication of a set of bounding box instructions. The bounding box engine may obtain either indication from at least one of a central processing unit (CPU) or a digital signal processor (DSP). The bounding box engine may determine a bounding box based on the set of reprojection distortions and the set of bounding box instructions. The bounding box engine may output an indication of the determined bounding box. The bounding box engine may output the indication to at least one of a graphics processing unit (GPU) or a geometric correction engine.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address excessive power and memory wastage to determine a bounding box for lens distortion correction (LDC). There is a need for improved bounding box calculation techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include memory; and at least one processor coupled to the memory and, based at least in part on information stored in the memory, the at least one processor may be configured to obtain, by a bounding box engine, an indication of a set of reprojection distortions. The at least one processor may be configured to obtain, by the bounding box engine, an indication of a set of bounding box instructions. The at least one processor may be configured to determine, by the bounding box engine, a bounding box based on the set of reprojection distortions and the set of bounding box instructions. The at least one processor may be configured to output an indication of the determined bounding box.

In some aspects, the techniques described herein relate to a method of graphics processing, including: obtaining, by a bounding box engine, an indication of a set of reprojection distortions; obtaining, by the bounding box engine, an indication of a set of bounding box instructions; determining, by the bounding box engine, a bounding box based on the set of reprojection distortions and the set of bounding box instructions; and outputting an indication of the determined bounding box.

In some aspects, the techniques described herein relate to a method, where obtaining the indication of the set of reprojection distortions includes obtaining the indication of the set of reprojection distortions from at least one of a central processing unit (CPU) or a digital signal processor (DSP), where obtaining the indication of the set of bounding box instructions includes obtaining the indication of the set of bounding box instructions from at least one of the CPU or the DSP.

In some aspects, the techniques described herein relate to a method, where outputting the indication of the determined bounding box includes outputting the indication of the determined bounding box to a graphics processor or graphics processing unit (GPU).

In some aspects, the techniques described herein relate to a method, where the set of reprojection distortions include at least one of: a head pose; a set of quad points; or a barrel distortion map.

In some aspects, the techniques described herein relate to a method, further including: determining a lens distortion correction (LDC) for the set of quad points based on the head pose and the barrel distortion map, where determining the bounding box based on the set of reprojection distortions and the set of bounding box instructions includes: determining the bounding box based on the determined LDC for the set of quad points and the set of bounding box instructions.

In some aspects, the techniques described herein relate to a method, where determining the bounding box based on the set of reprojection distortions and the set of bounding box instructions includes: determining, by a floating-point arithmetic and logical unit (FP ALU) of the bounding box engine, a floating-point (FP) value; and determining the bounding box based on the determined FP value.

In some aspects, the techniques described herein relate to a method, where determining the bounding box based on the set of reprojection distortions and the set of bounding box instructions includes: determining, by a special command engine of the bounding box engine, a barrel distortion map index; and determining the bounding box based on the determined barrel distortion map index.

In some aspects, the techniques described herein relate to a method, where determining the bounding box based on the set of reprojection distortions and the set of bounding box instructions includes: transforming, by a special command engine of the bounding box engine, a set of quad points based on a homography matrix; and determining the bounding box based on the transformed set of quad points.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4 illustrates an example of a reprojection and a distortion correction of a rendered object in a virtualized frame, in accordance with one or more techniques of this disclosure.

FIG. 5 illustrates a hardware diagram of an example bounding box engine, in accordance with one or more techniques of this disclosure.

FIG. 6 illustrates a logical diagram of an example bounding box engine, in accordance with one or more techniques of this disclosure.

FIG. 7 is a call flow diagram illustrating example communications between a control engine, a bounding box engine, and a graphics engine in accordance with one or more techniques of this disclosure.

FIG. 8 is a flowchart of an example method of graphics processing in accordance with one or more techniques of this disclosure.

FIG. 9 is a flowchart of an example method of graphics processing in accordance with one or more techniques of this disclosure.

FIG. 10 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purpose of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some aspects, a bounding box engine may exploit the sparsity of augmented reality (AR) content in reprojection. A bounding box may be an indication of a boundary of an object in a frame. In some aspects, the bounding box indicates the boundary by a set of quad points, or a set of x and y coordinates in a frame that defines an area about an object in the frame. A bounding box engine may include as any type of fixed function or programmable processing unit that can perform bounding box operations. The bounding box engine may include a coprocessor or a hardware accelerator for a graphics processing unit (GPU) or a computing processing unit (CPU). The bounding box engine may have a reprojection pre-distortion block that leverages a head pose, a set of quad points, and a distortion map (e.g., barrel distortion, pincushion distortion) to efficiently determine a bounding box for object distortion. The bounding box engine may be programmable, enabling flexible and efficient floating-point operations by levering an FP arithmetic and logical unit (FP ALU). An FP ALU may be a hardware component configured to perform FP operations. The bounding box engine may compute a lens distortion correction (LDC) for a set of quad points based on an obtained head pose and a distortion map. The bounding box engine may have control logic that is configured to run in batch mode to minimize a synchronization overhead between firmware and hardware. The control logic may also be configured to convert FP outputs into a late stage reprojection (LSR) specific FP type.

In some examples, a bounding box engine, or a bounding box system, may obtain an indication of a set of reprojection distortions. The set of reprojection distortions may define a distortion of reprojected content, such as, for example, a rendered object on a low-power display, such as a mobile, augmented reality (AR), or virtual reality (VR) display. The set of reprojection distortions may include, for example, at least one of a location of a head pose of a user, a set of quad points, or a distortion map. The set of quad points may include a set of x and y coordinates on a display that define an area about an object in the display. The bounding box engine may obtain an indication of a set of bounding box instructions. The set of bounding box instructions may include a set of calculations to compute a bounding box based on the set of reprojection distortions. The bounding box engine may obtain the indication of the set of reprojection distortions and the indication of the set of bounding box instructions from at least one of a central processing unit (CPU) or a digital signal processor (DSP). The bounding box engine may determine a bounding box based on the set of reprojection distortions and the set of bounding box instructions. The bounding box engine may output an indication of the determined bounding box. The bounding box engine may output the indication of the determined bounding box to at least one of a graphics processing engine (GPU) or a geometric correction engine for distorting an object based on the determined bounding box. A geometric correction engine may include a component, such as a hardware unit, a coprocessor, or a software module, that performs warping on an image, for example a rendered layer for display on a head-mounted display (HMD).

The bounding box engine may determine a lens distortion correction (LDC) for the set of quad points based on the head pose and the distortion map. The head pose may be indicated by a set of six degrees of freedom (6DOF) measurements of a head of a user. The distortion map may be indicated by a grid that maps regularly spaced points on a plane to points on a non-planar surface, such as a barrel-shaped screen of an HMD. The distortion map may be a barrel distortion, pincushion distortion, or complex distortion map that indicates how a flat image may be distorted to fit a non-planar display. The bounding box engine may determine the bounding box based on the determined LDC for the set of quad points and the set of bounding box instructions. For example, the set of bounding box instructions may include a set of instructions for mapping a set of quad points on a planar surface to a bounding box as distorted on a non-planar surface due to lens distortion. The bounding box engine may determine an FP value by an FP ALU of the bounding box. The bounding box engine may determine a barrel distortion map index based on a special command engine of the bounding box engine. A special command engine may be a hardware macro of a series of calculations, for example a sequence or a macro of a set of FP computations (e.g., FP addition operations, FP multiplication operations) and integer computations (e.g., integer addition operations, integer multiplication operations). The special command engine may be, for example, a series of 10 operations based on a reception of a single instruction command. The bounding box engine may transform a set of quad points based on a homography matrix by a special command engine. In other words, the special command engine may perform homography matrix multiplication in response to a reception of a single instruction command. The bounding box engine may determine the bounding box based on at least one of the determined barrel distortion map index (determined by a special command engine), transformed set of quad points (determined by a special command engine), or FP values (determined by an FP ALU). The bounding box engine may be included as a coprocessor in a wireless communications device. The coprocessor may have a direct path to a CPU or a graphics processor (e.g., a GPU), to accelerate inefficient aspects of the CPU/GPU.

Particular aspects of the subject matter described in this disclosure can be implemented to realize one or more of the following potential advantages. In some examples, by using a bounding box engine to determine a bounding box instead of using a CPU, the described techniques can be used to reduce latency, power, and/or memory used to determine the bounding box. In some examples, by using a bounding box engine to determine a bounding box instead of using a graphics processor (e.g., a GPU), the described techniques can be used to reduce power, and/or memory used to determine the bounding box.

The examples describe herein may refer to the use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

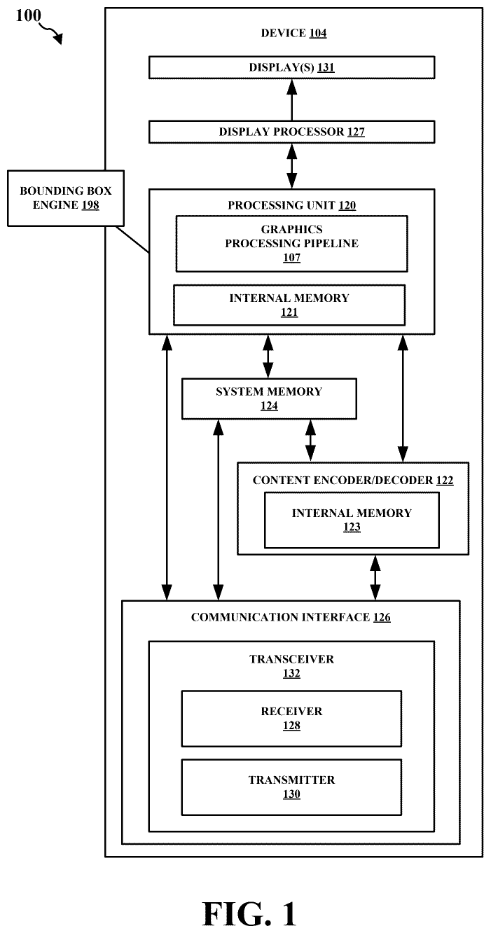

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentation thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or by a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors. A set of processors configured to perform a set of tasks may be configured to perform the set of tasks individually, or in any combination.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a bounding box engine 198 configured to obtain an indication of a set of reprojection distortions. The bounding box engine 198 may be configured to obtain an indication of a set of bounding box instructions. The bounding box engine 198 may be configured to determine a bounding box based on the set of reprojection distortions and the set of bounding box instructions. The bounding box engine 198 may be configured to output an indication of the determined bounding box. The bounding box engine 198 may include a coprocessor or a hardware accelerator to the processing unit 120. The bounding box engine 198 may have a direct path to the processing unit 120 to accelerate inefficient aspects of the processing unit 120, for example a generic CPU. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

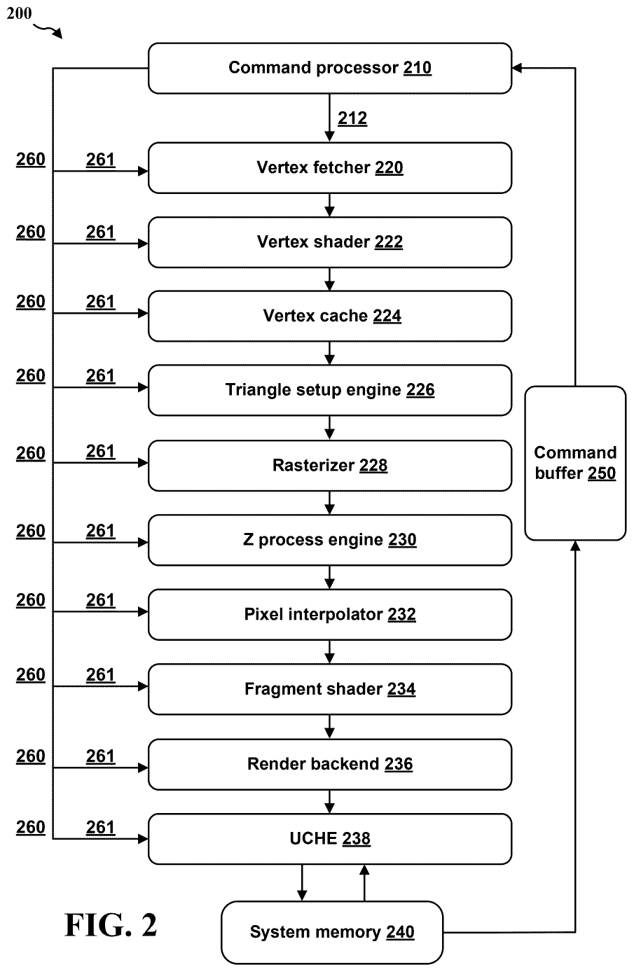

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

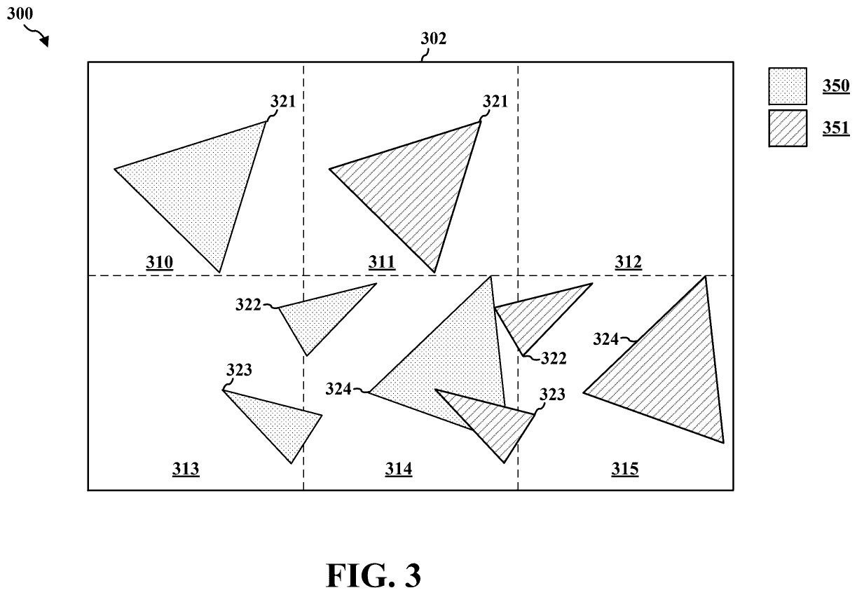

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

In some aspects, sparse AR content may display a subset of a potential visible field of view (FOV) of a user. In some aspects, a graphics display system for displaying AR content, for example for an HMU display, may not exploit sparsity as part of late stage reprojection (LSR) techniques. For example, the graphics display system may map each display pixel to a pixel in the render space as part of LSR, even if the pixel is not eventually lit. This limits the number of input layers that may be supported and costs a great deal of power to support mapping a display pixel to an unlit pixel.

In other aspects, a graphics display system may specify a target output bounding box for each layer of a display. The graphics display system may then process the display pixels within the output bounding box for that layer, while refraining from processing the display pixels outside the output bounding box.

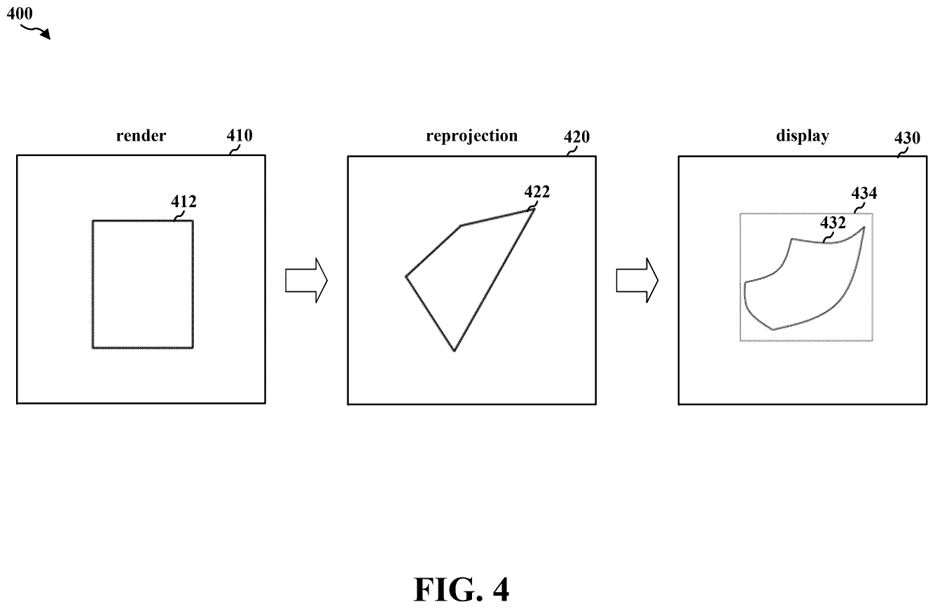

FIG. 4 is a diagram 400 illustrating a layer 410 having a rendered object 412, a layer 420 of a reprojection 422 of the rendered object 412, and a layer 430 of a distortion 432 of the reprojection 422. The distortion 432 may be bounded by a bounding box 434. A graphics display system may be configured to reproject the rendered object 412 to generate the reprojection 422. For example, given a set of corners c and a homography H (e.g., a perspective transformation from one camera view to another), a graphics display system may calculate c′ as H.c (e.g., a matrix multiplier operation) to determine the reprojected corners. The graphics display system may be configured to then determine a bounding box 434 for the distortion 432 to process the pixels within the bounding box 434 and refrain from processing the pixels outside the bounding box 434 to conserve resources. The graphics display system may compute the bounding boxes for each edge and merge the bounds for each edge. For example, a Four Cases Algorithm may be used to determine the bounds for each line segment. A graphics system may be configured to perform late stage reprojection (LSR) on a rendered object, such as the rendered object 412, to reproject and distort the rendered object at the display device (e.g., an HMU) to match the head pose of the user.

Determining an output bounding box for distortion of an object may increase the number of layers that can be supported by such a system and reduces the amount of power to process the same objects. However, the cost to determine the output bounding box is non-trivial, as a graphics display system may use a large number of calculations to determine a non-linear LDC. In order to improve the lifespan of an AR/VR glass, optimization features, such as features that may be used to determine an output bounding box, should use low power. Moreover, such systems should rapidly compute an output bounding box to ensure that the graphics display system can distort all of the objects for each layer before outputting a composed frame to a display. While a generic CPU or graphics processor (e.g., a GPU) may be configured to determine an output bounding box for distorting an object, generic CPUs may take a long time to calculate output bounding boxes (which may not keep up with real-time processing conditions) and may use a great deal of power to do so, while generic GPUs may use a small amount of time to calculate output bounding boxes but may use even more power to do so.

In some aspects, a specialized bounding box engine, such as a hardware accelerator or a coprocessor, may be configured to optimize determination of the output bounding box. An optimal bounding box engine may minimize the area of the bounding box. Such bounding box engines may have high compute conditions to optimize such calculations. Such bounding box engines may also be configured to have high throughput to support processing many layers per frame. Such bounding box engines may have low latency to determine the bounding box to ensure that the engine can distort the object rapidly. Such bounding box engines may be optimized to use a small amount of power to determine the bounding box, which may increase the lifespan of using AR/VR classes that implement optimized bounding box calculations. Such bounding box engines may be configured to be flexible, such that a single system may be used to determine output bounding boxes for different displays and/or different layers. Such bounding box engines may be configured to synchronize with display and/or hardware accelerators to leverage their optimization features as well.

By designing a bounding box engine, or a coprocessor, that is specifically configured to determine an output bounding box of a software layer, the bounding box engine may enable parallel processing, reducing latency and power consumption for determining the output bounding box. The bounding box engine may have a reprojection pre-distortion block configured to obtain a set of reprojection distortions from a controller, for example a CPU or a DSP network operations controller (NOC). In some aspects, software on a controller may make a call to firmware, and the firmware may call the LSR procedure at the bounding box engine. The set of reprojection distortions may include, for example, at least one of a head pose of a user, a set of quad points (e.g., x and y coordinates that bound the reprojection of a set of objects in a frame), or a barrel distortion map. The controller, or control engine, or a CPU or DSP may compute the head pose, quad points, and barrel distortion map, and provide them as inputs to the bounding box engine. The bounding box engine may read the head pose and barrel distortion map and compute a lens distortion correction (LDC) for the set of quad points based on the head pose and barrel distortion map. The bounding box engine may be a custom programmable hardware unit that enables flexible and efficient FP operations, as the bounding box engine may simply compute input instructions fed to the bounding box engine from an instruction memory (IMEM). In some aspects, the bounding box engine may be configured to have logic that runs in batch mode to minimize the synchronization overhead between firmware and hardware. In other words, a single firmware instruction may trigger a batch of operations at the bounding box engine. The bounding box engine logic may convert a set of institute of electrical and electronics engineers (IEEE) FP outputs into late stage reprojection (LSR) specific FP types. The bounding box engine may output the bounding box to a graphics engine, such as a graphics processor (e.g., a GPU) or a geometric correction module. The bounding box engine may distort the input quad points such that, in the distorted domain based on the head pose of the user, the object looks correct.

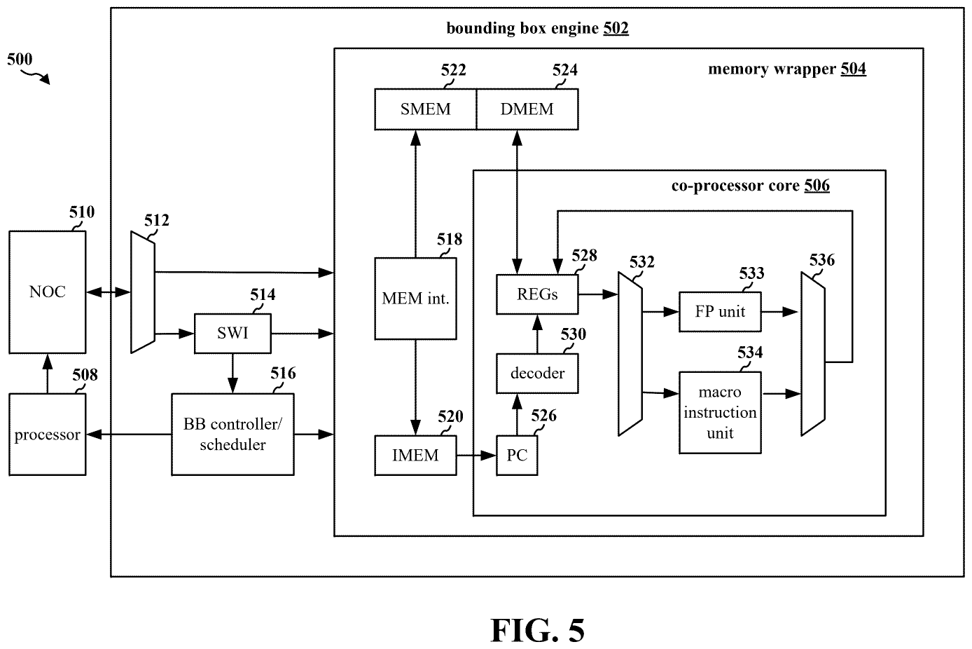

FIG. 5 includes a diagram 500 of a bounding box engine 502, in accordance with one or more techniques of this disclosure. The bounding box engine 502 may be, for example, a coprocessor or a hardware accelerator for a control engine, such as a CPU or a DSP. Here, the control engine is represented by a processor 508, which may have a direct path to the bounding box engine 502 via a bidirectional static random-access memory (SRAM) network unit (NU) interface between the network and operations controller (NOC) 510, shown as communicating with the MUX 512 (a multiplexer), and via an interrupt channel, shown as communicating with the bounding box (BB) controller/scheduler 516. The processor 508 may be a suitable control engine, for example a CPU or a DSP. The processor 508 may be any low-power processor tightly coupled to the bounding box engine 502 to minimize overhead communication costs. The bounding box engine 502 may save a determined bounding box to a memory, for example the shared memory (SMEM) 522 or the data memory (DMEM) 524. The SMEM 522 and the DMEM 524 may be logical partitions in the same physical memory accessible to both the bounding box engine 502 and to other components of a system, for example a CPU or a graphics processor (e.g., a GPU). A control engine, such as a CPU, may adjust the logical partition to increase or decrease a partition size of the SMEM 522 and/or the DMEM 524 as per the conditions of an algorithm.

The bounding box engine 502 may receive a set of commands from the processor 508 via the NOC 510. In response to receiving the set of commands from the processor 508, the bounding box engine 502 may execute FP operations via the FP unit 533 or BB-dedicated operations via the macro instruction unit 534. The MUX 512 may direct instructions received from the NOC 510 to the memory wrapper 504 of the bounding box engine 502 via an SRAM network interface unit (NIU) interface, or to a software interface (SWI) 514, which may feed each command from the NOC 510 to the memory wrapper 504 via an SWI register. The SWI 514 may also provide instructions to the BB controller/scheduler 516, which may provide feedback interrupts back to the processor 508, and may provide scheduling signals to the memory wrapper 504, for example start commands, control signal commands, and program counter (PC) reset commands.

The memory wrapper 504 may act as a memory wrapper for the bounding box engine 502, including a memory interface unit 518, which loads the instructions into the IMEM 520, which may be configured to store each instruction line-by-line (or data unit by data unit), and to the shared memory (SMEM) 522. Variable data for the instructions may be loaded into the data memory (DMEM) 524 from the SMEM 522 as appropriate. In some aspects, at power up of the bounding box engine 502, the bounding box engine 502 may load the commands from the IMEM 520 line-by-line. The bounding box engine 502 may fully load the IMEM 520 before the bounding box engine 502 processes a bounding box. In other words, the IMEM 520 may be loaded as a one-time memory write and a many-time memory read unit.

Instructions from the IMEM 520 may be provided to a PC 526 of the co-processor core 506, which may be decoded sequentially address-by-address via a decoder 530, which may process commands to perform operations on data variables stored in the set of registers 528. The MUX 532 may route data variables through the FP unit 533 for an FP or integer operation (e.g., addition, multiplication), or through the macro instruction unit 534 for a set of batch operations. The DEMUX 536 (a demultiplexer) may then direct results of the operations to the set of registers 528, which may selectively be stored in the DMEM 524 for output to a graphics engine, such as a geometric correction module or a graphics processor (e.g., a GPU).

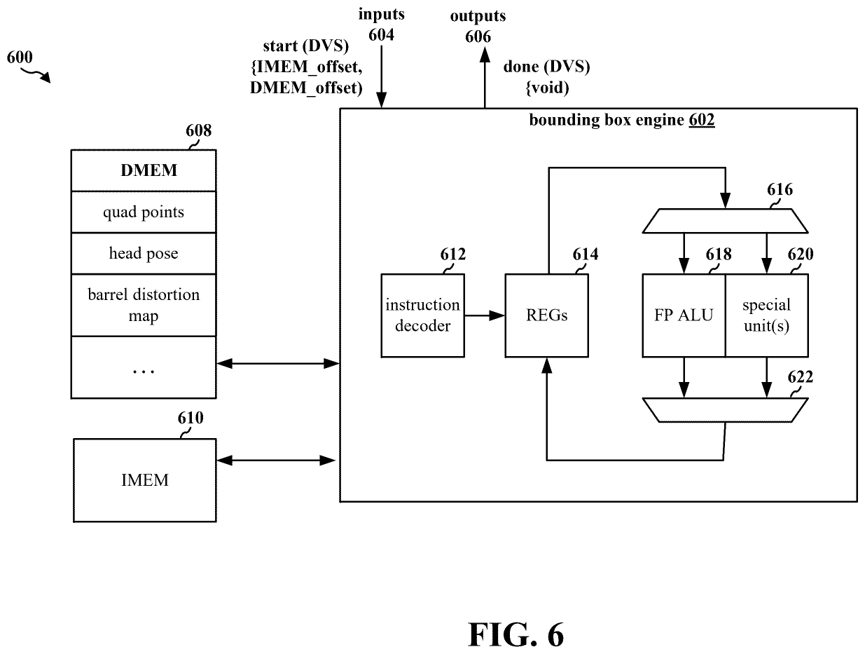

FIG. 6 is a diagram 600 illustrating data logic of an exemplary bounding box engine, such as the bounding box engine 502 in FIG. 5, in accordance with one or more techniques of this disclosure. The DMEM 608 may store a set of inputs to the bounding box engine, such as a set of quad points, a head pose, and/or a barrel distortion map. The IMEM 610 may store instructions from a control engine, such as a CPU or a DSP, and may function as a scalable data virtualization service (DVS) interface with a flexible command engine.

The instructions from the IMEM 610 may be fed into an instruction decoder 612, which may process each instruction line-by-line to perform operations on a set of variables stored in the set of registers 614. The MUX 616 may direct the variables to be operated upon by the set of FP ALUs 618 for simple FP operations (e.g., addition or multiplication of FP values or integers), or to be operated upon by the set of special units 620. A special unit may be specialized hardware configured to perform a sequence of operations on a set of input variables based on a single instruction decoded by the instruction decoder 612. For example, a special unit may receive a single instruction to operate on a set of inputs, and in response may perform a series of FP operations on the set of inputs. The set of special units 620 may be configured to perform bounding box operations for the bounding box engine 602. The DEMUX 622 may then direct results of the operations to appropriate memory addresses of the set of registers 614, which may be output to appropriate memory addresses of the DMEM 608.

A set of inputs 604, for example a DVS start command, a set of DMEM addresses, and a set of IMEM addresses, may initiate execution of a set of bounding box instructions by the bounding box engine 602, while a set of outputs 606 from the bounding box engine 602, for example a DVS done feedback, may indicate that the bounding box engine 602 has completed its computations. The set of outputs 606 may include an interrupt that may be used as an indication to inform a control unit (e.g., a CPU) that the bounding box engine 602 outputs are available in a memory, such as the DMEM 608. Upon receiving the interrupt from the set of outputs 606, a control unit may read the output saved on the memory by the bounding box engine 602.

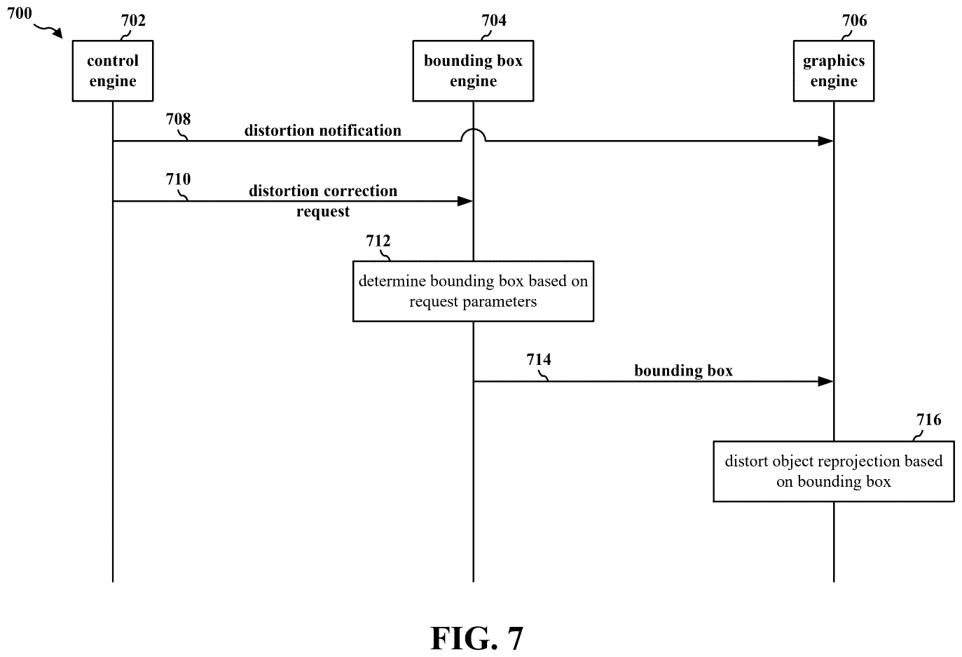

FIG. 7 is a call flow diagram 700 illustrating example communications between a control engine 702, a bounding box engine 704, and a graphics engine 706, in accordance with one or more techniques of this disclosure. The control engine 702 may be, for example, a CPU or a DSP. The graphics engine 706 may be, for example, a geometric correction module or a graphics processor (e.g., a GPU) configured to perform distortion on an object based on an output bounding box. The bounding box engine 704 may be a co-processor or a hardware accelerator that has a direct path to the control engine 702 to minimize communications latency.

The control engine 702 may output an indication 708 of a distortion notification to the graphics engine 706. The graphics engine 706 may receive the indication 708 of the distortion notification from the control engine 702. The indication 708 of the distortion notification may include a rendered frame and an instruction to reproject the rendered frame and distort the reprojection based on an output bounding box received from the bounding box engine 704. In response to receiving the indication 708 of the distortion notification from the control engine 702, the graphics engine 706 may wait for an indication of an output bounding box to be received from the bounding box engine 704.

The control engine 702 may output an indication 710 of a distortion correction request to the bounding box engine 704. The bounding box engine 704 may obtain the indication 710 of the distortion correction request from the bounding box engine 704. The indication 710 of the distortion correction request may include a set of reprojection distortions, for example a head pose, a set of quad points, and a barrel distortion map. The indication 710 of the distortion correction request may include a set of bounding box instructions, for example a set of FP operations and a set of macros to perform, such as barrel distortion map calculations or homography matrix multiplication.

At 712, the bounding box engine 704 may determine a bounding box based on the request parameters indicated by the indication 710 of the distortion correction request. The bounding box engine 704 may output an indication 714 of the bounding box to the graphics engine 706. The graphics engine 706 may obtain the indication 714 of the bounding box from the bounding box engine 704. At 716, the graphics engine 706 may distort an object reprojection based on the received bounding box.

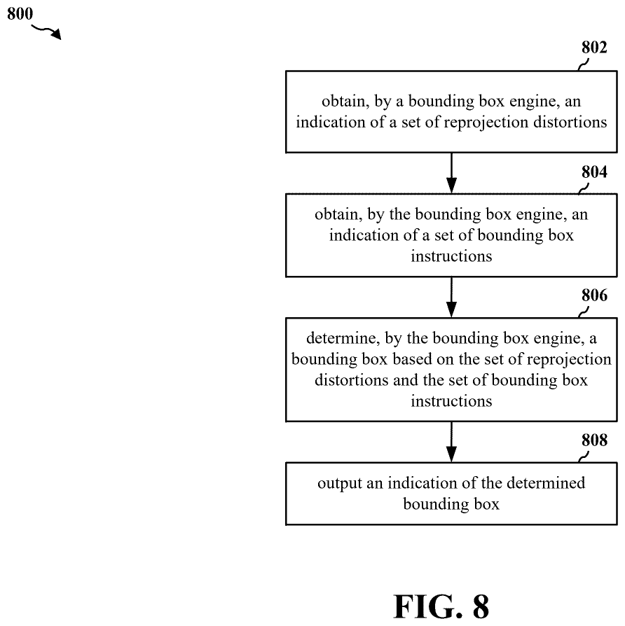

FIG. 8 is a flowchart 800 of an example method of graphics processing in accordance with one or more techniques of this disclosure. The method may be performed by an apparatus, such as an apparatus for graphics processing, a coprocessor, a hardware accelerator, a graphics processor (e.g., a GPU), a CPU, a DPS, a geometric correction engine, a wireless communication device, and the like, as used in connection with the aspects of FIGS. 1-7.

At 802, the apparatus may obtain, by a bounding box engine, an indication of a set of reprojection distortions. For example, referring to FIG. 7, the bounding box engine 704 may obtain an indication 710 of a distortion correction request, which may include an indication of a set of reprojection distortions, for example a head pose, a set of quad points, and/or a barrel distortion map. 802 may be performed by the bounding box engine 198 in FIG. 1.

At 804, the apparatus may obtain, by the bounding box engine, an indication of a set of bounding box instructions. For example, referring to FIG. 7, the bounding box engine 704 may obtain an indication 710 of a distortion correction request, which may include an indication of a set of bounding box instructions, for example a set of instructions for a set of FP ALUs and a set of special units of a bounding box engine. 804 may be performed by the bounding box engine 198 in FIG. 1.

At 806, the apparatus may determine, by the bounding box engine, a bounding box based on the set of reprojection distortions and the set of bounding box instructions. For example, referring to FIG. 7, the bounding box engine 704 may, at 712, determine a bounding box based on the set of reprojection distortions and the set of bounding box instructions. 806 may be performed by the bounding box engine 198 in FIG. 1.

At 808, the apparatus may output an indication of the determined bounding box. For example, referring to FIG. 7, the bounding box engine 704 may output an indication 714 of the determined bounding box to a graphics engine 706. 808 may be performed by the bounding box engine 198 in FIG. 1.

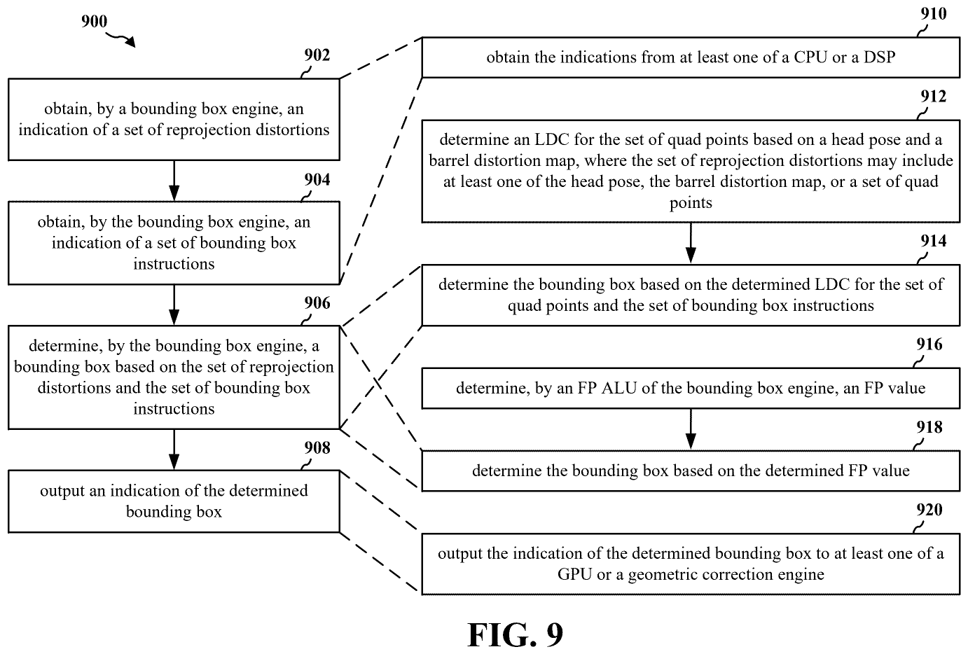

FIG. 9 is a flowchart 900 of an example method of graphics processing in accordance with one or more techniques of this disclosure. The method may be performed by an apparatus, such as an apparatus for graphics processing, a coprocessor, a hardware accelerator, a graphics processor (e.g., a GPU), a CPU, a DPS, a geometric correction engine, a wireless communication device, and the like, as used in connection with the aspects of FIGS. 1-7.

At 902, the apparatus may obtain, by a bounding box engine, an indication of a set of reprojection distortions. For example, referring to FIG. 7, the bounding box engine 704 may obtain an indication 710 of a distortion correction request, which may include an indication of a set of reprojection distortions, for example a head pose, a set of quad points, and/or a barrel distortion map. 902 may be performed by the bounding box engine 198 in FIG. 1.

At 904, the apparatus may obtain, by the bounding box engine, an indication of a set of bounding box instructions. For example, referring to FIG. 7, the bounding box engine 704 may obtain an indication 710 of a distortion correction request, which may include an indication of a set of bounding box instructions, for example a set of instructions for a set of FP ALUs and a set of special units of a bounding box engine. 904 may be performed by the bounding box engine 198 in FIG. 1.

At 906, the apparatus may determine, by the bounding box engine, a bounding box based on the set of reprojection distortions and the set of bounding box instructions. For example, referring to FIG. 7, the bounding box engine 704 may, at 712, determine a bounding box based on the set of reprojection distortions and the set of bounding box instructions. 906 may be performed by the bounding box engine 198 in FIG. 1.

At 908, the apparatus may output an indication of the determined bounding box. For example, referring to FIG. 7, the bounding box engine 704 may output an indication 714 of the determined bounding box to a graphics engine 706. 908 may be performed by the bounding box engine 198 in FIG. 1.

At 910, the apparatus may obtain the indications of 902 and/or 904 from at least one of a CPU or a DSP. For example, referring to FIG. 7, the bounding box engine 704 may obtain the indications from the control engine 702, which may be a CPU and/or a DSP. 910 may be performed by the bounding box engine 198 in FIG. 1.

At 912, the apparatus may determine an LDC for the set of quad points based on a head pose and a barrel distortion map, where the set of reprojection distortions may include at least one of the head pose, the barrel distortion map, or a set of quad points. For example, referring to FIG. 7, the bounding box engine 704 may, at 712, determine an LDC for the set of quad points based on a head pose and a barrel distortion map of the distortion correction request. The set of reprojection distortions of the distortion correction request may include at least one of the head pose, the barrel distortion map, or a set of quad points. 912 may be performed by the bounding box engine 198 in FIG. 1.

At 914, the apparatus may determine, by the bounding box engine, a bounding box based on the set of reprojection distortions and the set of bounding box instructions by determining the bounding box based on the set of reprojection distortions and the set of bounding box instructions by determining the bounding box based on the determined LDC for the set of quad points and the set of bounding box instructions. For example, referring to FIG. 7, the bounding box engine 704 may, at 712, determine the bounding box based on the determined LDC for the set of quad points and the set of bounding box instructions. 914 may be performed by the bounding box engine 198 in FIG. 1.

At 916, the apparatus may determine, by the bounding box engine, a bounding box based on the set of reprojection distortions and the set of bounding box instructions by determining, by an FP ALU of the bounding box engine, an FP value. For example, referring to FIG. 7, the bounding box engine 704 may, at 712, determine, by an FP ALU of the bounding box engine (e.g., an FP ALU of the set of FP ALUs 618), an FP value. 916 may be performed by the bounding box engine 198 in FIG. 1.

At 918, the apparatus may determine, by the bounding box engine, a bounding box based on the set of reprojection distortions and the set of bounding box instructions by determining the bounding box based on the set of reprojection distortions and the set of bounding box instructions by determining the bounding box based on the determined FP value. For example, referring to FIG. 7, the bounding box engine 704 may, at 712, determine the bounding box based on the determined FP value. 918 may be performed by the bounding box engine 198 in FIG. 1.

At 920, the apparatus may output an indication of the determined bounding box by outputting the indication of the determined bounding box to at least one of a GPU or a geometric correction engine. For example, referring to FIG. 7, the bounding box engine 704 may output the indication of the determined bounding box to the graphics engine 706. The graphics engine 706 may include a GPU and/or a geometric correction engine. 920 may be performed by the bounding box engine 198 in FIG. 1.

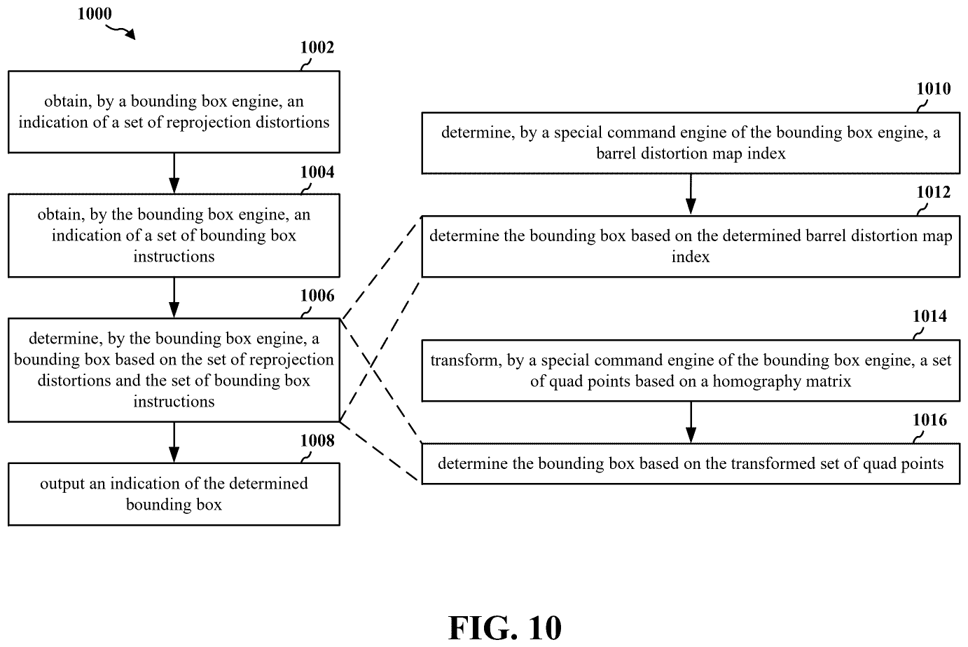

FIG. 10 is a flowchart 1000 of an example method of graphics processing in accordance with one or more techniques of this disclosure. The method may be performed by an apparatus, such as an apparatus for graphics processing, a coprocessor, a hardware accelerator, a graphics processor (e.g., a GPU), a CPU, a DPS, a geometric correction engine, a wireless communication device, and the like, as used in connection with the aspects of FIGS. 1-7.

At 1002, the apparatus may obtain, by a bounding box engine, an indication of a set of reprojection distortions. For example, referring to FIG. 7, the bounding box engine 704 may obtain an indication 710 of a distortion correction request, which may include an indication of a set of reprojection distortions, for example a head pose, a set of quad points, and/or a barrel distortion map. 1002 may be performed by the bounding box engine 198 in FIG. 1.

At 1004, the apparatus may obtain, by the bounding box engine, an indication of a set of bounding box instructions. For example, referring to FIG. 7, the bounding box engine 704 may obtain an indication 710 of a distortion correction request, which may include an indication of a set of bounding box instructions, for example a set of instructions for a set of FP ALUs and a set of special units of a bounding box engine. 1004 may be performed by the bounding box engine 198 in FIG. 1.

At 1006, the apparatus may determine, by the bounding box engine, a bounding box based on the set of reprojection distortions and the set of bounding box instructions. For example, referring to FIG. 7, the bounding box engine 704 may, at 712, determine a bounding box based on the set of reprojection distortions and the set of bounding box instructions. 1006 may be performed by the bounding box engine 198 in FIG. 1.

At 1008, the apparatus may output an indication of the determined bounding box. For example, referring to FIG. 7, the bounding box engine 704 may output an indication 714 of the determined bounding box to a graphics engine 706. 1008 may be performed by the bounding box engine 198 in FIG. 1.

At 1010, the apparatus may determine the bounding box based on the set of reprojection distortions and the set of bounding box instructions by determining, by a special command engine of the bounding box engine, a barrel distortion map index. For example, referring to FIG. 7, the bounding box engine 704 may, at 712, determine, by a special command engine of the bounding box engine (e.g., one of the special units of the set of special units 620 in FIG. 6), a barrel distortion map index. 1010 may be performed by the bounding box engine 198 in FIG. 1.

At 1012, the apparatus may determine, by the bounding box engine, a bounding box based on the set of reprojection distortions and the set of bounding box instructions by determining the bounding box based on the determined barrel distortion map index. For example, referring to FIG. 7, the bounding box engine 704 may, at 712, determine the bounding box based on the determined barrel distortion map index. 1012 may be performed by the bounding box engine 198 in FIG. 1.

At 1014, the apparatus may transform, by a special command engine of the bounding box engine, a set of quad points based on a homography matrix. For example, referring to FIG. 7, the bounding box engine 704 may, at 712, transform, by a special command engine of the bounding box engine (e.g., one of the special units of the set of special units 620 in FIG. 6), a set of quad points based on a homography matrix. 1014 may be performed by the bounding box engine 198 in FIG. 1.

At 1016, the apparatus may determine, by the bounding box engine, a bounding box based on the set of reprojection distortions and the set of bounding box instructions by determining the bounding box based on the set of reprojection distortions and the set of bounding box instructions by determining the bounding box based on the transformed set of quad points. For example, referring to FIG. 7, the bounding box engine 704 may, at 712, determine the bounding box based on the transformed set of quad points. 1016 may be performed by the bounding box engine 198 in FIG. 1.

In configurations, a method or an apparatus for graphics processing is provided. The apparatus may be a graphics processor (e.g., a GPU), a CPU, or some other processor that may perform graphics processing. In aspects, the apparatus may be the processing unit 120 within the device 104, or may be some other hardware within the device 104 or another device. The apparatus may include means for obtaining, by a bounding box engine, an indication of a set of reprojection distortions. The apparatus may further include means for obtaining, by the bounding box engine, an indication of a set of bounding box instructions. The apparatus may further include means for determining, by the bounding box engine, a bounding box based on the set of reprojection distortions and the set of bounding box instructions. The apparatus may further include means for outputting an indication of the determined bounding box. The means may include the bounding box engine 198 in FIG. 1.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

An indication of a set of data may include the data itself, or a reference to the data, for example a memory address where the data may be retrieved by the receiving entity, or an index to a set of data (e.g., an index of 1 that represents the series of bits 1100101). A single indication may also include a set of indications, for example an array of memory addresses or a plurality of index references.

The following aspects are illustrative only and may be combined with other aspects or teachings described herein, without limitation.

Aspect 1 is a method of graphics processing, comprising: obtaining, by a bounding box engine, an indication of a set of reprojection distortions; obtaining, by the bounding box engine, an indication of a set of bounding box instructions; determining, via the bounding box engine, a bounding box based on the set of reprojection distortions and the set of bounding box instructions; and outputting an indication of the determined bounding box.

Aspect 2 is the method of aspect 1, wherein obtaining the indication of the set of reprojection distortions comprises obtaining the indication of the set of reprojection distortions from at least one of a central processing unit (CPU) or a digital signal processor (DSP), wherein obtaining the indication of the set of bounding box instructions comprises obtaining the indication of the set of bounding box instructions from at least one of the CPU or the DSP.

Aspect 3 is the method of either of aspects 1 or 2, wherein outputting the indication of the determined bounding box comprises outputting the indication of the determined bounding box to at least one of a graphics processing unit (GPU) or a geometric correction engine.

Aspect 4 is the method of any of aspects 1 to 3, wherein the set of reprojection distortions comprise at least one of: a head pose; a set of quad points; or a barrel distortion map.

Aspect 5 is the method of aspect 4, further comprising: determining a lens distortion correction (LDC) for the set of quad points based on the head pose and the barrel distortion map, wherein determining the bounding box based on the set of reprojection distortions and the set of bounding box instructions comprises: determining the bounding box based on the determined LDC for the set of quad points and the set of bounding box instructions.

Aspect 6 is the method of any of aspects 1 to 5, wherein determining the bounding box based on the set of reprojection distortions and the set of bounding box instructions comprises: determining, via a floating-point arithmetic and logical unit (FP ALU) of the bounding box engine, a floating-point (FP) value; and determining the bounding box based on the determined FP value.

Aspect 7 is the method of any of aspects 1 to 6, wherein determining the bounding box based on the set of reprojection distortions and the set of bounding box instructions comprises: determining, via a special command engine of the bounding box engine, a barrel distortion map index; and determining the bounding box based on the determined barrel distortion map index.

Aspect 8 is the method of any of aspects 1 to 7, wherein determining the bounding box based on the set of reprojection distortions and the set of bounding box instructions comprises: transforming, via a special command engine of the bounding box engine, a set of quad points based on a homography matrix; and determining the bounding box based on the transformed set of quad points.

Aspect 9 is an apparatus for graphics processing including at least one processor coupled to a memory and configured to implement a method as in any of aspects 1-8.

Aspect 10 may be combined with aspect 9 and includes that the apparatus is a wireless communication device.

Aspect 11 is an apparatus for graphics processing including means for implementing a method as in any of aspects 1-8.

Aspect 12 is a computer-readable medium (e.g., a non-transitory computer-readable medium) storing computer executable code, the code when executed by at least one processor causes the at least one processor to implement a method as in any of aspects 1-8.

Various aspects have been described herein. These and other aspects are within the scope of the following claims.

What is claimed is:

1. An apparatus for graphics processing, comprising:
memory; and
a processor coupled to the memory and, based at least in part on information stored in the memory, the processor is configured to:
obtain, by a bounding box engine, an indication of a set of reprojection distortions;
obtain, by the bounding box engine, an indication of a set of bounding box instructions;
determine, by the bounding box engine, a bounding box based on the set of reprojection distortions and the set of bounding box instructions; and
output an indication of the determined bounding box.

2. The apparatus of claim 1, wherein, to obtain the indication of the set of reprojection distortions, the processor is configured to obtain the indication of the set of reprojection distortions from at least one of a central processing unit (CPU) or a digital signal processor (DSP), wherein, to obtain the indication of the set of bounding box instructions, the processor is configured to obtain the indication of the set of bounding box instructions from at least one of the CPU or the DSP.

3. The apparatus of claim 1, wherein, to output the indication of the determined bounding box, the processor is configured to:
output the indication of the determined bounding box to at least one of a graphics processing unit (GPU) or a geometric correction engine.

4. The apparatus of claim 1, wherein the set of reprojection distortions comprise at least one of:
a head pose;
a set of quad points; or
a barrel distortion map.

5. The apparatus of claim 4, wherein the processor is further configured to:
determine a lens distortion correction (LDC) for the set of quad points based on the head pose and the barrel distortion map, wherein, to determine the bounding box based on the set of reprojection distortions and the set of bounding box instructions, the processor is configured to:
determine the bounding box based on the determined LDC for the set of quad points and the set of bounding box instructions.

6. The apparatus of claim 1, wherein, to determine the bounding box based on the set of reprojection distortions and the set of bounding box instructions, the processor is configured to:
determine, by a floating-point arithmetic and logical unit (FP ALU) of the bounding box engine, a floating-point (FP) value; and
determine the bounding box based on the determined FP value.

7. The apparatus of claim 1, wherein, to determine the bounding box based on the set of reprojection distortions and the set of bounding box instructions, the processor is configured to:
determine, by a special command engine of the bounding box engine, a barrel distortion map index; and
determine the bounding box based on the determined barrel distortion map index.

8. The apparatus of claim 1, wherein, to determine the bounding box based on the set of reprojection distortions and the set of bounding box instructions, the processor is configured to:
transform, by a special command engine of the bounding box engine, a set of quad points based on a homography matrix; and
determine the bounding box based on the transformed set of quad points.

9. The apparatus of claim 1, wherein the apparatus comprises a wireless communication device.

10. A method of graphics processing, comprising:
obtaining, by a bounding box engine, an indication of a set of reprojection distortions;
obtaining, by the bounding box engine, an indication of a set of bounding box instructions;
determining, by the bounding box engine, a bounding box based on the set of reprojection distortions and the set of bounding box instructions; and
outputting an indication of the determined bounding box.

11. The method of claim 10, wherein obtaining the indication of the set of reprojection distortions comprises obtaining the indication of the set of reprojection distortions from at least one of a central processing unit (CPU) or a digital signal processor (DSP), wherein obtaining the indication of the set of bounding box instructions comprises obtaining the indication of the set of bounding box instructions from at least one of the CPU or the DSP.

12. The method of claim 10, wherein outputting the indication of the determined bounding box comprises outputting the indication of the determined bounding box to at least one of a graphics processing unit (GPU) or a geometric correction engine.

13. The method of claim 10, wherein the set of reprojection distortions comprise at least one of:
a head pose;
a set of quad points; or
a barrel distortion map.

14. The method of claim 13, further comprising:
determining a lens distortion correction (LDC) for the set of quad points based on the head pose and the barrel distortion map, wherein determining the bounding box based on the set of reprojection distortions and the set of bounding box instructions comprises:
determining the bounding box based on the determined LDC for the set of quad points and the set of bounding box instructions.

15. The method of claim 10, wherein determining the bounding box based on the set of reprojection distortions and the set of bounding box instructions comprises:
determining, by a floating-point arithmetic and logical unit (FP ALU) of the bounding box engine, a floating-point (FP) value; and
determining the bounding box based on the determined FP value.

16. The method of claim 10, wherein determining the bounding box based on the set of reprojection distortions and the set of bounding box instructions comprises:
determining, by a special command engine of the bounding box engine, a barrel distortion map index; and
determining the bounding box based on the determined barrel distortion map index.

17. The method of claim 10, wherein determining the bounding box based on the set of reprojection distortions and the set of bounding box instructions comprises:
transforming, by a special command engine of the bounding box engine, a set of quad points based on a homography matrix; and
determining the bounding box based on the transformed set of quad points.

18. A computer-readable medium storing computer executable code, the code when executed by a processor, causes the processor to:
obtain, by a bounding box engine, an indication of a set of reprojection distortions;
obtain, by the bounding box engine, an indication of a set of bounding box instructions;
determine, by the bounding box engine, a bounding box based on the set of reprojection distortions and the set of bounding box instructions; and
output an indication of the determined bounding box.

19. The computer-readable medium of claim 18, wherein the set of reprojection distortions comprise a head pose, a set of quad points, and a barrel distortion map, wherein the code when executed by the processor, causes the processor to:
determine a lens distortion correction (LDC) for the set of quad points based on the head pose and the barrel distortion map, wherein, to determine the bounding box based on the set of reprojection distortions and the set of bounding box instructions, the code when executed by the processor, causes the processor to:
determine the bounding box based on the determined LDC for the set of quad points and the set of bounding box instructions.

20. The computer-readable medium of claim 18, wherein, to determine the bounding box based on the set of reprojection distortions and the set of bounding box instructions, the code when executed by the processor, causes the processor to:
determine, by a floating-point arithmetic and logical unit (FP ALU) of the bounding box engine, a floating-point (FP) value; and
determine the bounding box based on the determined FP value.
